(19) United States
(12) Patent Application Publication
(10) Pub. No.: US 2015/0046497 A1
(43) Pub. Date: Feb. 12, 2015

(54) SYSTEM AND METHOD FOR TRACKING ITEMS AT AN EVENT

(71) Applicants: Dennis Wayne Campbell, JR., Gainesville, VA (US); Joseph Michael King, SR., Nokesville, VA (US)

(72) Inventors: Dennis Wayne Campbell, JR., Gainesville, VA (US); Joseph Michael King, SR., Nokesville, VA (US)

(73) Assignee: CKS Group, LLC, Gainesville, VA (US)

(21) Appl. No.: 13/961,873

(22) Filed: Aug. 7, 2013

(51) Int. Cl. G06F 17/30

(52) U.S. Cl. CPC G06F 17/30289
USPC 707/802

(57) ABSTRACT

A network device generates secure item records for items evaluated at an event. A network device receives, at a provider network, event registration information including an event location and receiving item information for an item (e.g., a car, boat, etc.) to be evaluated at the event. The systems and methods assign an enrollment code for the item and provide the enrollment code to an event participant as part of a pre-registration procedure. The network device receives an item registration record, for the item, with a first digital signature; receives an item judging record, for the item, with a second digital signature; and receives an item judging validation, for the item, with a third digital signature. The network device generates a hash value from the first, second, and third digital signatures and stores the item registration record, the item judging record, the item judging validation, and the hash value.

### RELATED APPLICATIONS

This application claims priority under 35 U.S.C. §119, based on U.S. Provisional Patent Application No. 61/743,354 filed Aug. 31, 2012, the disclosure of which is hereby incorporated by reference herein.

### BACKGROUND

Items presented at events, such as conventions or trade shows, are often evaluated by a critics, judges, or experts. It is often desirable to maintain records of these evaluations associated with a particular item. For example, in the case of a car show, judges' scores of items (e.g., vehicles) should be maintained as part of the item history and may affect valuation of the item.

### BRIEF DESCRIPTION OF THE DRAWINGS

FIG. 1 is a diagram illustrating an exemplary environment in which systems and/or methods described herein may be implemented;

FIG. 2 is a block diagram illustrating exemplary components of a device that may correspond to one of the devices of FIG. 1;

FIGS. 3-5B are exemplary user interfaces for event an item registration at an event according to an implementation described herein;

FIG. 6 is a flow diagram of an exemplary process for registering an event with items to be tracked;

FIG. 7 is a flow diagram of an exemplary process for registering an item at an event location;

FIG. 8 is a flow diagram of an exemplary process for providing judging records for an item at the event location; and

FIG. 9 is a flow diagram of an exemplary process for receiving and managing item records from an event according to an implementation described herein.

### DETAILED DESCRIPTION OF PREFERRED EMBODIMENTS

The following detailed description refers to the accompanying drawings. The same reference numbers in different drawings may identify the same or similar elements.

Systems and methods provided herein may generate secure item records for items evaluated at an event. The systems and methods may include receiving, at a provider network, event registration information including an event location and receiving item information for an item (e.g., a car, boat, animal, furniture, etc.) to be evaluated at the event. The systems and methods may assign an enrollment code for the item and provide the enrollment code to an event participant as part of a pre-registration procedure.

A user device (e.g., a smart phone or tablet computer) may be provided with an application (referred to herein as an event data management application) to facilitate item registration and/or item evaluation at the event. At the time/location of the event, a user (e.g., an event staff person) may use the application on the user device to scan the enrollment code previously obtained from a network device and associate the enrollment code with an item description, an item photograph, an item serial number, and/or a serial number photograph from the item. The user device may identify a location of the user device proximate to the time and vicinity of the scanning the enrollment code. The user device may then combine, in an item registration record, the enrollment code, the location information, and the one or more of the item description, the item photograph, the item serial number, and/or the serial number photograph. The user device may generate a digital signature for the item registration record and send to the provider network the item registration record with the digital signature.

As described further herein, the event data management application (or a different application) residing on the user device may be used to collect judging results and or judging verifications. Similar to the item registration record, each of the judging results and judging verifications may be assigned a unique digital signature before the user device sends the judging results and judging verifications to the provider network.

According to an implementation described herein, the provider network may receive the item registration record with the first digital signature, the item judging record with the second digital signature, and the item judging validation with the third digital signature. The systems and methods may generate a hash value from the first, second, and third digital signatures and may store, in a memory and as a single record, the item registration record, the item judging record, the item judging validation, and the hash value. This process ensures that the event data entered into the system remains intact and unchanged.

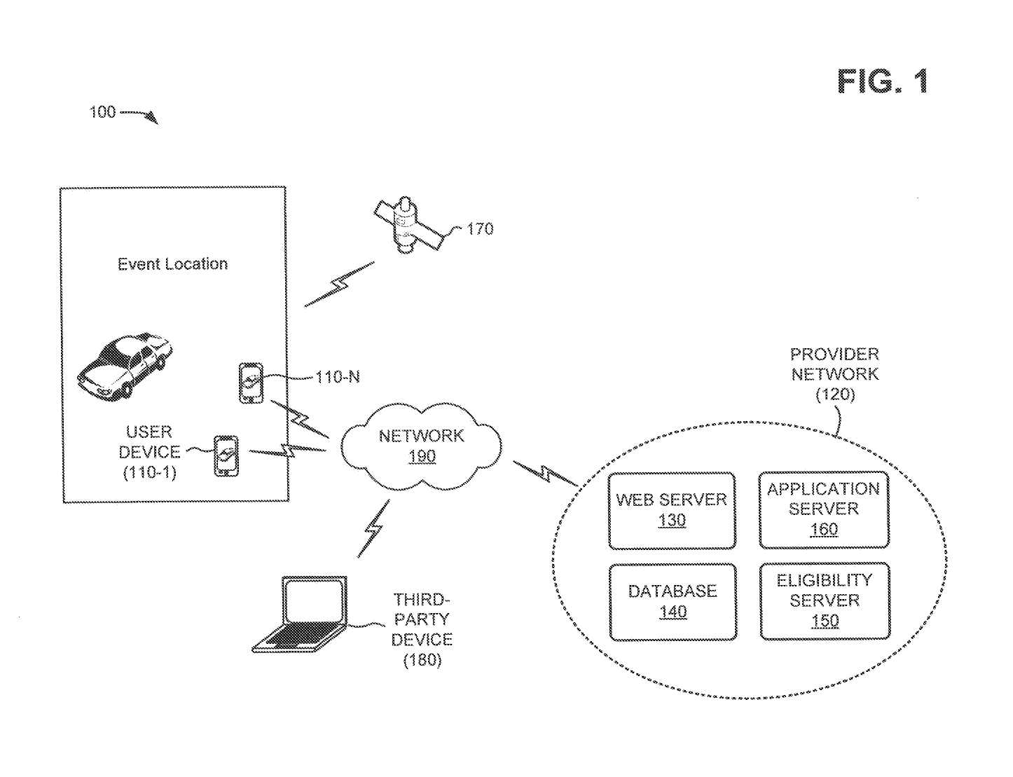

FIG. 1 is a diagram illustrating an exemplary environment 100 in which systems and/or methods described herein may be implemented. As illustrated, environment 100 may include user devices 110-1 through 110-N (collectively “user devices 110” and individually “user device 110”), a provider network 120 that includes a web server 130, a database 140, an eligibility server 150, and an application server 160; a global positioning system 170; and a third-party device 180 interconnected by a network 190. Components of environment 100 may be connected via wired and/or wireless links.

User device 110 may include a computational or communication device. User device 110 may include, for example, a personal communications system (PCS) terminal, a smart phone, a tablet computer, a laptop computer, or another type of mobile computational or communication devices. In another implementation, user device 110 may include a fixed-location computing device, such as a desktop computer, or a fixed-location computing device in communication with a mobile accessory (e.g., a camera in wired/wireless communication with a personal computer). User device 110 may generally be equipped with hardware and software to provide location detecting capabilities and to capture images of a local environment. For example, user device 110 may include a location identification system (e.g., global positioning system (GPS) or another assisted location determining system) and a content recording device (e.g., a camera, a video camera, etc.). In implementations described herein, user device 110 may be configured with an application (e.g., an event data management application) to collect registration information (e.g., including photographs and/or code scans) and/or judging information for items at an event, generate a digital signature for a record of the collected information, and provide the collected information and digital signature to provider network 120.

Provider network 120 may include network devices to supply backend services to user devices 110 for tracking items at events. Provider network 120 may include, for example, one or more private IP networks that use a private IP address space. Provider network 120 may include a local area network (LAN), an intranet, a private wide area network (WAN), etc. In one implementation, provider network 120 may implement one or more Virtual Private Networks (VPNs) for providing communication between, for example, any of web server 130, database 140, and eligibility server 150. Provider network 120 may be protected/separated from other networks, such as network 190, by a firewall. Although shown as a single element in FIG. 1, provider network 120 may include a number of separate networks.

Web server 130 may include one or more network or computational devices to manage service requests from eligible user devices 110. In one implementation, web server 130 may provide an application (e.g., an event data management application) and/or instructions to user device 110 to enable user device 110 to collect information for items at events. For example, the application and/or instructions may provide user interfaces to solicit pre-registration codes, photographs, and other user input used to generate item registration records, item judging records, and/or judging verifications. The application and/or instructions may also generate digital signatures for uploading records (e.g., item registration files, item judging files, etc.). In another implementation, as described further herein, web server 130 may provide multiple types of browser-based user interfaces to facilitate event registrations, item registrations (e.g., for items at particular events), and item judging records (e.g., for items at particular events). Web server 130 may receive event registrations, item registration records, item judging records, and/or judging verifications from user devices 110, may process/collate the received data, and may forward the data to database 140 for storage.

Database 140 may include one or more databases or other data structures to store records for event registrations, item registrations, and/or item record uploads (e.g., provided by user devices 110 via web server 130). In one implementation, database 140 may also store data retrieved from and/or used by eligibility server 150.

Eligibility server 150 may include one or more network or computational devices to provide backend support for authorizing use of a provider network 120 by user devices 110. For example, eligibility server 150 may store identification information for registered users and/or user devices 110 to verify that a particular user/user device 110 has access to services and/or information provided by provider network 120. Upon verifying eligibility of a user/user device 110, eligibility server 150 may, for example, provide a link (e.g., a URL) to permit user device 110 to access other devices in provider network 120, such as web server 130.

Application server 160 may include one or more network or computational devices to perform services accessed through web server 130. For example, application server 160 may manage application downloads provided to user devices 110, may process incoming data files for storage in database 140, and/or may generate hash values for uploaded records.

Positioning system 170 may include one or more devices configured to provide location information for user devices 110. In some implementations, location information may include, for example, GPS information or another form of global navigation satellite system (GNSS) information. In one implementation, positioning system 170 may include one or more cellular towers, wherein user devices may retrieve location information in the form of cellular tower triangulation information. Additionally, or alternatively, positioning system 170 may include a GPS satellite to determine a location of user device 110. In still other implementations, positioning system 170 may include a device with a fixed address or location associated with a wired network connection or IP address. For example, user device 110 may report, as location data, a service set identifier (SSID) (e.g., associated with a local wireless router) to which user devices 110 may be connected.

Third-party device 180 may include a computational or communication device, such as a personal computer, tablet computer, or mobile communication device. In one implementation, third-party device 180 may include a device similar to user device 110. Third-party device 180 may include, for example, an email program or web browser to facilitate communications with devices in provider network 120.

Network 190 may include a local area network (LAN); an intranet; the Internet; a wide area network (WAN), such as a cellular network, a satellite network, a fiber optic network, a private WAN, or a combination of the Internet and a private WAN; etc., that is used to transport data. Although shown as a single element in FIG. 1, network 190 may include a number of separate networks that function to provide services to user devices 110 and/or provider network 120.

In FIG. 1, the particular arrangement and number of components of network 200 are illustrated for simplicity. In practice there may be more user devices 110, provider networks 120, web servers 130, databases 140, eligibility servers 150, application servers 160, positioning systems 170, third-party devices 180, and/or networks 190. For example, there may be hundreds or thousands of user devices 110.

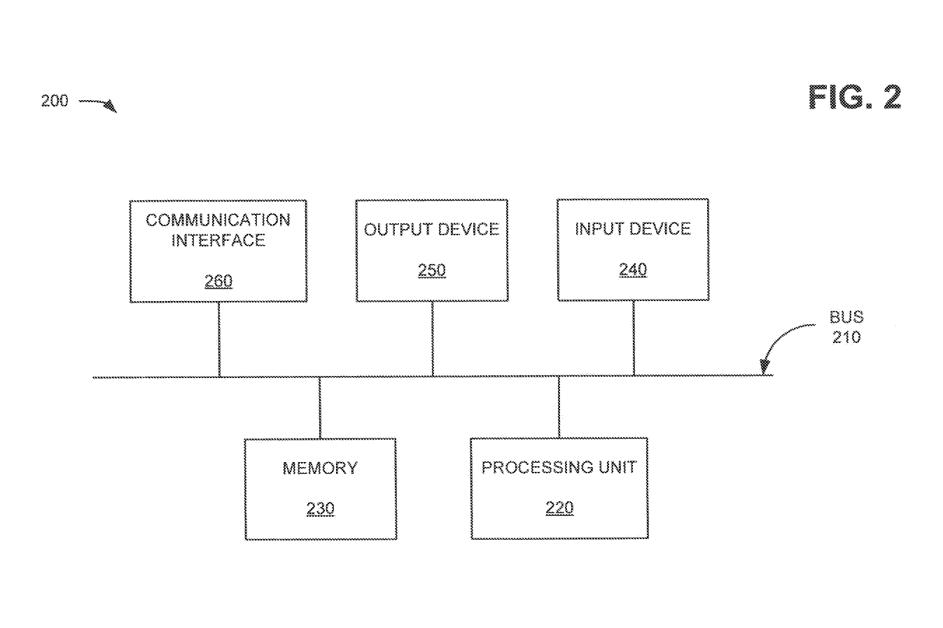

FIG. 2 is a diagram of exemplary components of a device 200. Each of user device 110, web server 130, eligibility server 150, application server 160, and third-party device 180 may be implemented/installed as a combination of hardware and software on one or more of device 200. As shown in FIG. 2, device 200 may include a bus 210, a processing unit 220, a memory 230, an input device 240, an output device 250, and a communication interface 260.

Bus 210 may permit communication among the components of device 200. Processing unit 220 may include one or more processors or microprocessors that interpret and execute instructions. In other implementations, processing unit 220 may be implemented as or include one or more application specific integrated circuits (ASICs), field programmable gate arrays (FPGAs), or the like.

Memory 230 may include a random access memory (RAM) or another type of dynamic storage device that stores information and instructions for execution by processing unit 220, a read only memory (ROM) or another type of static storage device that stores static information and instructions for the processing unit 220, and/or some other type of magnetic or optical recording medium and its corresponding drive for storing information and/or instructions.

Input device 240 may include a device that permits a user to input information to device 200, such as a keyboard, a keypad, a mouse, a pen, a microphone, a camera, one or more biometric mechanisms, and the like. Output device 250 may include a device that outputs information to the operator, such as a display, a speaker, etc.

Communication interface 260 may include any transceiver-like mechanism that enables device 200 to communicate with other devices and/or systems. For example, communication interface 260 may include mechanisms for communicating with other devices, such as other devices of network 200.

As described herein, device 200 may perform certain operations in response to processing unit 220 executing software instructions contained in a computer-readable medium, such as memory 230. A computer-readable medium may include a non-transitory memory device. A memory device may be implemented within a single physical memory device or spread across multiple physical memory devices. The software instructions may be read into memory 230 from another computer-readable medium or from another device via communication interface 260. The software instructions contained in memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may include fewer components, different components, differently arranged components, or additional components than those depicted in FIG. 2. As an example, in some implementations, a display may not be included in device 200. In these situations, device 200 may be a “headless” device that does not include input device 240. Alternatively, or additionally, one or more components of device 200 may perform one or more other tasks described as being performed by one or more other components of device 200.

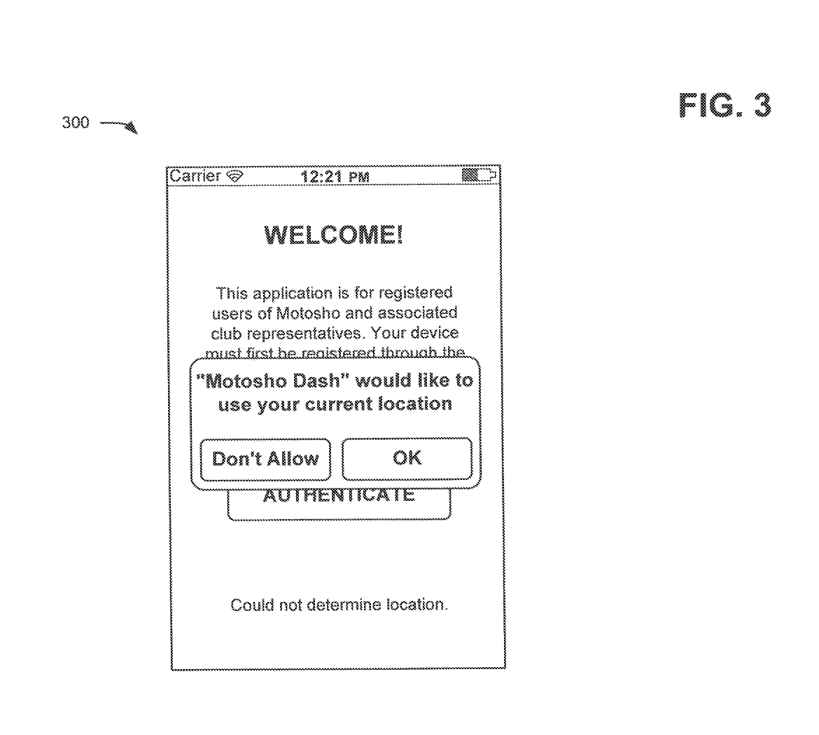

FIGS. 3-5B include exemplary user interfaces that may be provided on user device 110 via the event data management application. FIG. 3 provides a user interface 300 for identifying a location of user device 110 during an item registration at an event. For example, the event data management application may request, via user interface 300, permission of a user to identity and use location information of user device 110 (e.g., as determined with information from positioning system 170). If allowed by the user, the event data management application may incorporate location information into data collections processes described herein.

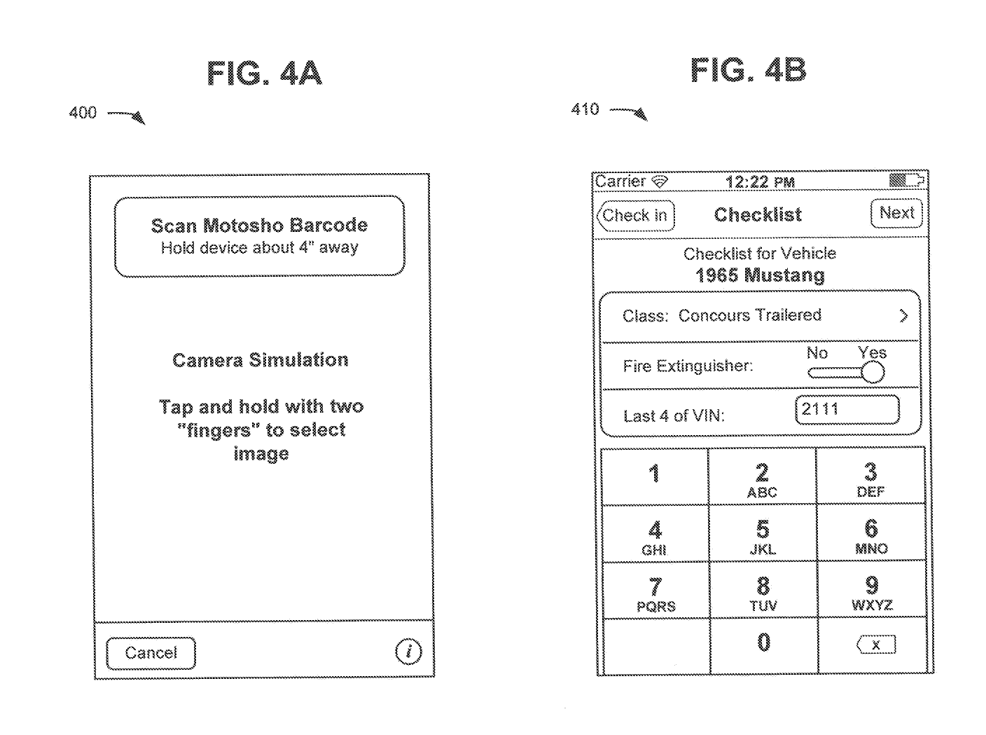

FIG. 4A provides a user interface 400 for scanning a bar code for an item during an item registration at an event. FIG. 4B provides a sample user interface 410 for manipulating a data record of an item during an item registration at an event. As shown in FIG. 4A, user interface 400 of the event data management application may provide instructions and an interface to capture (e.g., via an integrated camera) and interpret a barcode (e.g., a one- or two-dimensional barcode) associated with an item to be evaluated. As shown in FIG. 4B, user interface 410 of the event data management application may provide instructions and an interface to input additional information about the item to be evaluated relative to event location and associate the additional information with a portion of a unique item identifier (e.g., an item's VIN).

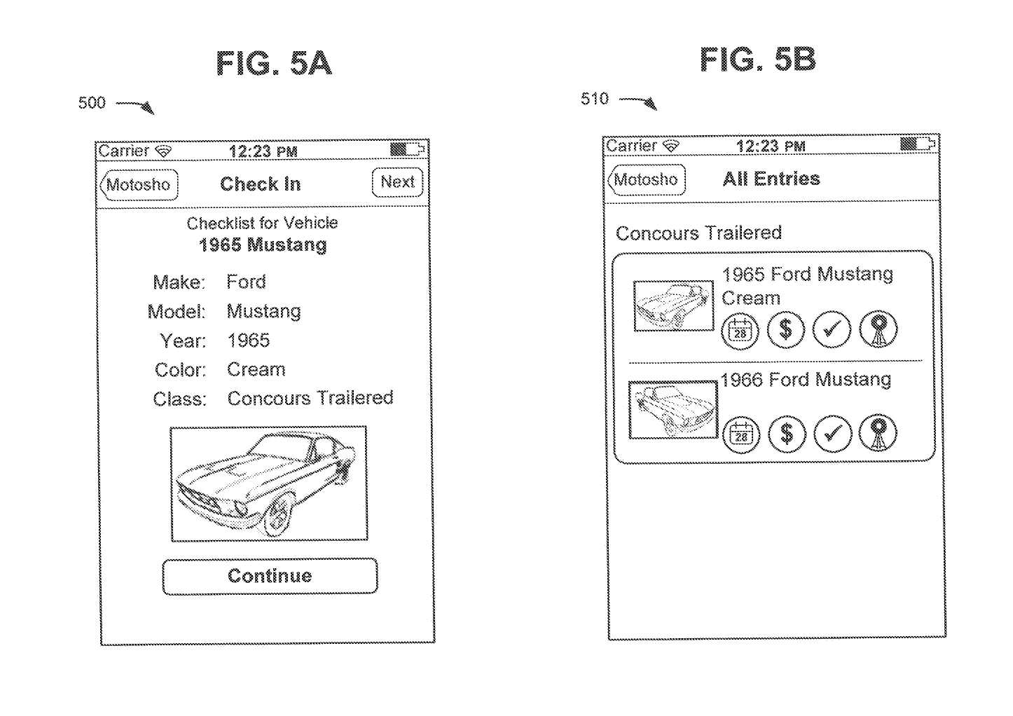

FIG. 5A provides a user interface 500 indicating a pre-registered item during an item registration at an event. FIG. 5B provides a user interface 510 summarizing multiple items registered at an event. As shown in FIG. 5A, user interface 500 may present item information for a pre-registered item based on, for example, a bar code reading (e.g., collected via user interface 400) or a manually entered selection. As shown in FIG. 5A, user interface 510 may include item information for multiple items that may be registered at an event. Details of each item may be selected, for example, by selecting a particular item displayed in user interface 510.

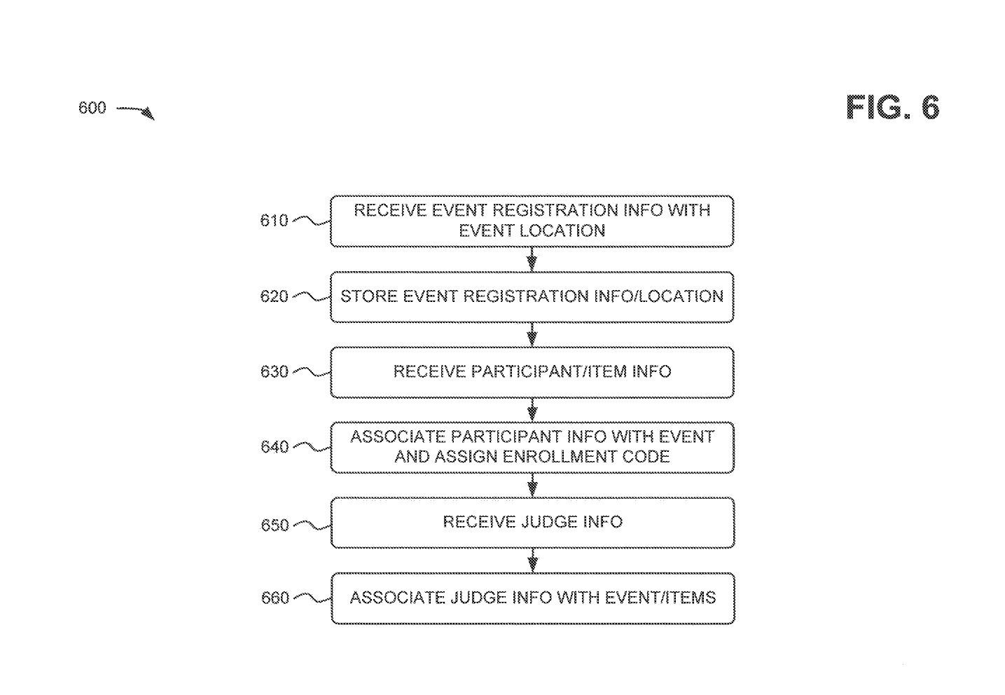

FIG. 6 is a flow diagram of an exemplary process 600 for registering an event with items to be tracked. In one implementation, process 600 may be performed by user device 110. In another implementation, some or all of process 600 may be performed by another device or group of devices, including or excluding user device 110. For example, a device in provider network 120 may perform one or more parts of process 600.

Process 600 may include receiving event registration information with an event location (block 610) and storing the event registration information with location information (block 620). For example, an event coordinator may use a user device 110 to access web server 130 and provide event registration information for a scheduled event, such as a trade show. Registration information may include, for example, an event date/time, an event name, and/or an event location. The event location may include, for example, a physical address, a location name (e.g., a convention center name, an airport name, etc.), latitude and longitude, or GPS coordinates, etc. Web server 130 may receive the event registration information and store the event registration information in database 140.

Process 600 may also include receiving participant information (block 630) and associating the participant information with the event and assigning an enrollment code (block 640). For example, participants and/or event coordinators may access web server 130 to upload information about expected participants and/or expected items (e.g., items to be evaluated) for the event. In one implementation, participant information may be collected from individuals (e.g., via user devices 110 or third-party devices 180) as part of a participant pre-registration process for the event. In another implementation, participant information may be provided as part of the event registration. Participant information may include items and item categories (e.g., for which particular items may be judged). Web server 130 may receive the participant information and associate the information with the event information in, for example, database 140. In one implementation, web server 130 may assign an event-unique enrollment code for each item.

Process 600 may also include receiving judge information (block 650) and associating the judge information with the event (block 660). For example, judges (or other evaluators) and/or event coordinators may access web server 130 to upload information about expected judges for the event. In one implementation, judge information may be collected from individual judges (e.g., via user devices 110) as part of a judge registration process for the event. In another implementation, judge information may be provided as part of the event registration. Judges may be associated with, for example, particular items and/or categories for the event. Web server 130 may receive the judge information and associate the judge information with the event information in, for example, database 140.

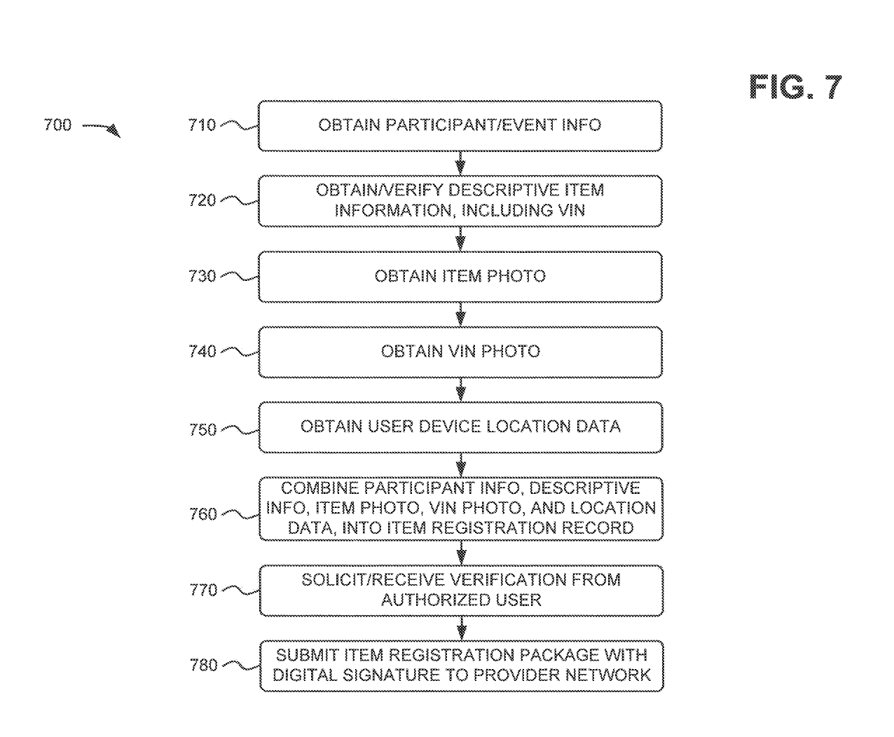

FIG. 7 is a flow diagram of an exemplary process 700 for registering an item at an event location. In one implementation, process 700 may be performed by user device 110. In another implementation, some or all of process 700 may be performed by another device or group of devices, including or excluding user device 110. For example, a device in provider network 120 may perform one or more parts of process 700.

Process 700 may include obtaining participant and event information (block 710) and obtaining and/or verifying descriptive item information, including a vehicle identification number (VIN) (block 720). For example, a user of user device 110 (e.g., an event staff person) may register an event participant at the beginning of an event. The participant may provide personal verification (e.g., an identification card, pre-registration letter, etc.) and/or item verification (e.g., a pre-registration enrollment code from process 600), and present an item to be judged at the event. The item to be judged may be listed with descriptive information (e.g., particular color, year, make, and model of a vehicle) and at least a portion of a unique item identifier (e.g., a VIN, serial number, etc.). User device 110 may include, for example, an event data management application. The user (e.g., event staff person) may use user device 110 to enter the participant/item information or retrieve the participant information from an earlier registration (e.g., from web server 130/database 140). In one implementation, descriptive information about the item to be judged can be retrieved from provider network 120 and populated in a user interface of the event data management application based on an enrollment code provided at the time of the event registration.

Process 700 may also include obtaining an item photograph (block 730), obtaining a VIN photograph (block 740), and obtaining user device location data (block 750). For example, user device 110 may capture one or more images of the item (e.g., using an integrated camera) at the event site and one or more images of the item VIN (e.g., as printed/stamped on the item). In one implementation, user device 110 may prompt the user to take the necessary photographs. User device 110 may obtain location data (e.g., of user device 110 at the time of the photographs), using for example, GPS information or other location determining techniques.

Process 700 may further include combining the participant information, the descriptive item information, the item image, the VIN image, and the location data into an item registration record (block 760). For example, user device 110 may collect information described above in connection with blocks 710-750 and may store the collected information as a single record or a single set of associated items. In one implementation, user device 110 may store the single record or set of associated items in a temporary cache or another local memory location. In another implementation, the single record for the item registration package may include less or additional information than the information described above in connection with blocks 710-750.

Process 700 may also include soliciting and/or receiving verification from an authorized user (block 770). For example, at some point prior to transferring item registration data, user device 110 may solicit a pass code (e.g., a personal identification number, security code, etc.) from the user. The pass code may be assigned to the user prior to the item registration process by, for example, an event coordinator. Assuming a valid pass code is received, user device 110 may permit item registration data to be uploaded to, for example, a device (e.g., database 140 or another device) in provider network 120.

Process 700 may also include submitting the item registration package with a digital signature to a backend system (block 780). For example, the registration package may be provided to, for example, web server 130 (or another device in provider network 120) using an encryption process. As part of the data transfer process, user device 110 may initiate an exchange of keys (such as public/private key pairs and/or digital certificates) or other credentials so that the registration package can be securely tied to other communications between user device 110 and web server 130. For example, along with an initial device set up, web server 130 may provision authentication keys to user device 110 to initiate a handshake sequence between user device 110 and web server 130. As described herein, user device 110 may submit the item registration package using an “originating key set” that is valid only for the duration of the event.

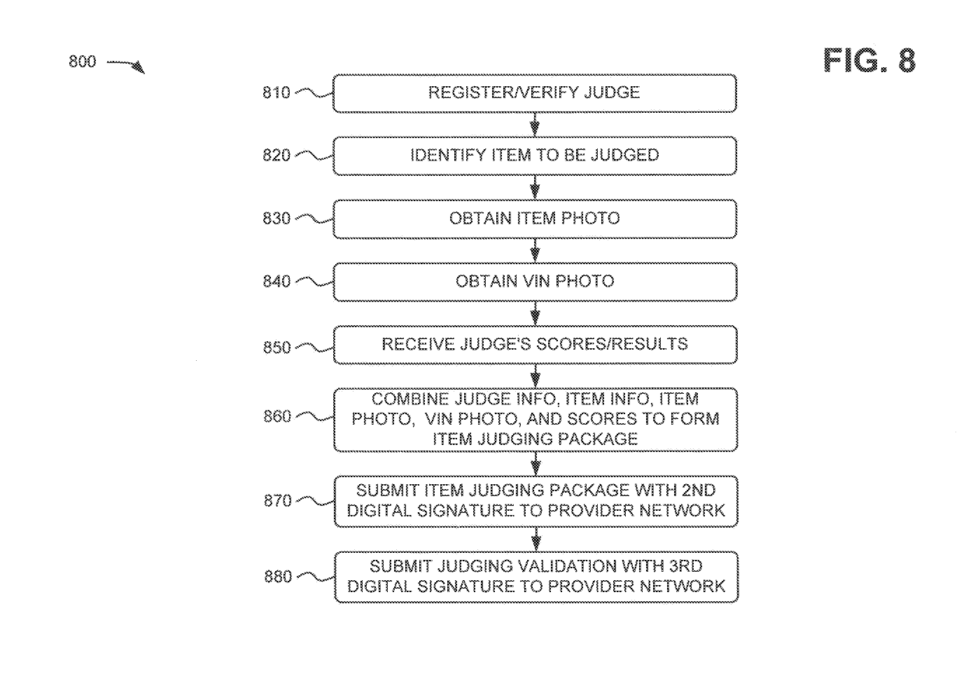

FIG. 8 is a flow diagram of an exemplary process 800 for providing judging records for an item at the event location. In one implementation, process 800 may be performed by user device 110. In another implementation, some or all of process 800 may be performed by another device or group of devices, including or excluding user device 110. For example, a device in provider network 120 may perform one or more parts of process 800.

Process 800 may include registering and/or verifying a judge (block 810), and identifying an item to be judged (block 820). For example, a judge may identify himself/herself using an authentication procedure (e.g., providing unique judge information such as a user name/password). Once authenticated, user device 110 may grant the judge access to an event data management application. The event data management application may allow the judge to enter a description/serial number of an item to be judged or to select an item from a pre-populated list of registered items (e.g., items registered using process 700 above).

Process 800 may include obtaining an item photograph (block 830) and obtaining a VIN photograph (block 840). For example, user device 110 may capture, at the time of judging, one or more images of the item (e.g., using an integrated camera) and one or more images of the item VIN (e.g., as printed/stamped on the item). In one implementation, user device 110 may prompt the judge to take the necessary photographs (e.g., prior to providing user interface to record judging scores. In one implementation, user device 110 may again obtain location data (e.g., of user device 110 at the time of the photographs/judge inputs, using for example, GPS information or other location determining techniques.

Process 800 may include receiving a judge's scores and/or results for the item (block 850) and combining the judge information, the item information, the item photograph, the VIN photograph, and the judge's scores to form an item judging package (block 860). For example, user device 110 may collect information described above in connection with blocks 810-850 and may store the collected information as a single record or a single set of associated items. In one implementation, user device 110 may store the single record or set of associated items in a temporary cache or another local memory location. In another implementation, the single record for the item judging package may include less or additional information than the information described above in connection with blocks 810-850.

Process 800 may also include submitting the item judging package with a second digital signature to a provider network (block 870). For example, user device 110 may submit the item judging package using an “originating key set” that is valid only for the duration of the event. The judging package with the second digital signature may be provided, for example, to web server 130 for storage in database 140.

Additionally, or alternatively, process 800 may include submitting a judging validation with a third digital signature (block 880). For example, a user (e.g., event staff or judge) of user device 110 may retrieve the item judging package from a local memory. The user may perform a final review of the judging results and provide a final approval and/or (physical) signature. The final approval may be combined with user identification information (e.g., a user name and password of the final reviewer). User device 110 may store the validated judging file and submit the validated judging file with the third digital signature to provider network 120.

According to implementations herein, two pairs of encryption keys may be used for digital signatures—an “origination key set” and an “alteration key set.” While both keys of a key pair are generated on a backend server (e.g., web server 130 or application server 160) only one key of each pair is actually stored on each device, with a backend device (e.g., web server 130) and a front end device (e.g., user device 110) both containing an individual key each. The key located on user device 110 (e.g., the event data management application) would exist for the duration of the event for which it was provisioned and then become useless afterward. That is, the “origination key set” is a temporarily assigned key for a single event at a certain time and place. Thus, a digital signature provided by the origination key set mechanism is irrefutable in origination. The second key, the “alteration key set” is granted to or revoked from a party of distinction or preference. While the temporarily-assigned origination key would insert or create the initial data system record (e.g., an item judging record or item registration record), the alteration key would be able to override and potentially alter the record based on privilege.

The following scenario is provided as an example: Assume an event occurs and a volunteer at an event is given privilege to register an item at the event (e.g., a car show). The event chairperson or administrator assigns a Personal Identification Number (PIN) to the volunteer. The volunteer logs into the event data management application on his/her user device 110 using the PIN to enable the user interface/menus. Each time the menu task is completed (e.g., an item is registered or judged, etc.), the submission within the event data management application requires the PIN (e.g., corresponding to an origination key) to commit the transaction. At the end of the event, the volunteer leaves and finds the application PIN no longer allows access to the device menus or submission of data. A few days later, a participant from the event disputes the final score of a judged item and asks for a review and possible “re-tally” of event results for the particular item. Upon review, a decision is made to withdraw some deductions from the item judging record. The event manager/administrator logs in with his PIN (e.g., corresponding to an alteration key) and makes an adjustment. The event manager/administrator later discovers upon conclusion of another show that his PIN does not allow for him to make changes because his role has changed and his altering capability has been revoked.

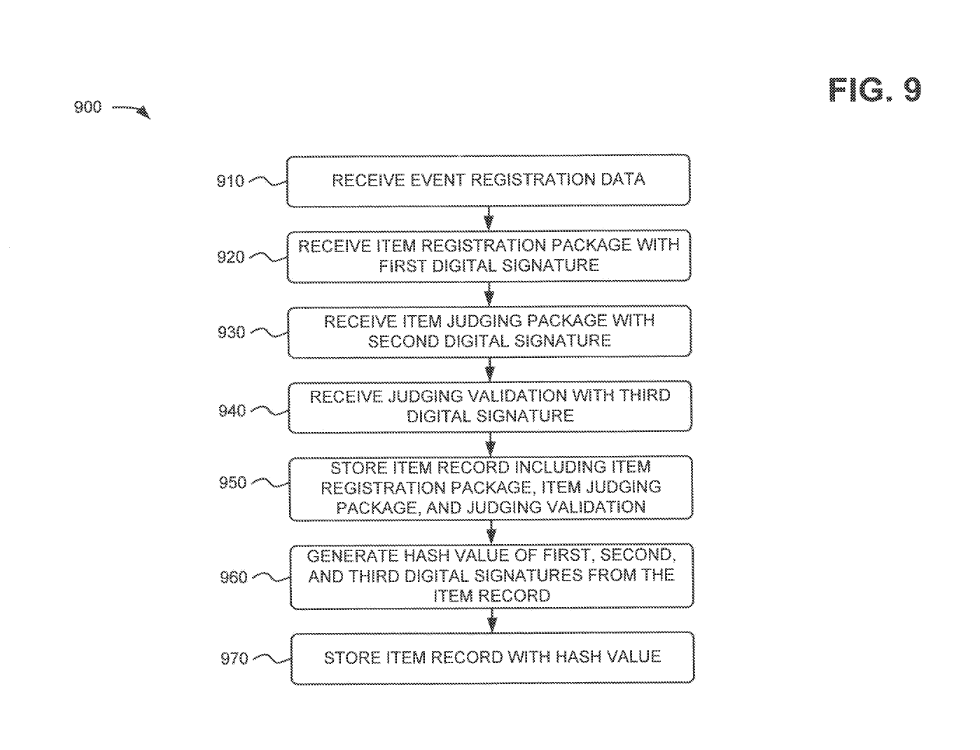

FIG. 9 is a flow diagram of an exemplary process 900 for receiving and managing item records from an event. In one implementation, process 900 may be performed by web server 130. In another implementation, some or all of process 900 may be performed by another device or group of devices, including or excluding web server 130. For example, another device in provider network 120 may perform one or more parts of process 900.

Process 900 may include receiving event registration data (block 910), receiving an item registration package with a first digital signature (block 920), receiving an item judging package with a second digital signature (block 930), and receiving a judging validation with a third digital signature (block 940). For example, web server 130 may receive an event registration for which items to be evaluated/judged will be associated. Items may be pre-registered with enrollment codes assigned. At the time of the event, an item registration package with a first digital signature may be received (e.g., via the event data management application and process 700 described above). At the time the item is judged, an item judging package with a second digital signature and a judging validation with a third digital signature may be received (via the event data management application and process 800 described above).

Process 900 may include storing the item record including the item registration package, the item judging package, and the judging validation (block 950). For example, web server 130 may receive the item record including the item registration package, the item judging package, and the judging validation, for a particular item, from one or more user device 110. Web server 130 may associated the item record including the item registration package, the item judging package, and the judging validation using the assigned enrollment code and/or other item information and may store the receive data in database 140.

Process 900 may include generating a hash value of the first, second, and third digital signatures from the item record (block 960) and associating the hash value with the item record (block 970). For example, a final digital signature of the three previous signatures may be generated to establish a comparison point. The final digital signature may include a hash value of the first, second, and third digital signatures that may be calculated from a particular hash algorithm, such as MD5, SHA-1, SHA-256, etc. The final digital signature may be associated with the item record and stored with the item record in database 140.

Item records stored in database 140 may be accessed, for example, by third-parties with authorization (e.g., using third-party devices 180). The final digital signature with each item record may be used to establish a comparison point similar to a hash for downloaded files. If the hash of the downloaded file doesn't match the published hash, it is assumed the file is incomplete, corrupt or tampered with. Similarly, if the digital signature of each item record does not match a published digital signature from process block 970, the item record may be considered suspect. If any piece of the item record is modified (e.g., as an authorized modification), the digital signatures must be recreated or the records will reflect that the data has been tampered with. If something in the item record has to be modified after the fact, the original record, a description of the modification, and user signature would become the basis for the new digital signature.

Systems and/or methods described herein may be used to establish an irrefutable record of an item's attendance (or presence), judging, and scoring, at an event. The systems and/or methods described herein use a unique combination of two-factor authentication, GPS coordinates, date-time stamp, and digital signatures to ensure the records stored are accurate and irrefutable.

In an exemplary illustration, a person registering a vehicle at an event may begin by taking a photograph of the vehicle using the event data management application running on a iPhone or Android device with the embedded GPS coordinates enabled as part of a check in process to establish the vehicle is present at the show. Additionally, the person can photograph the VIN tag and validate the last N digits by entering them into a text box (as prompted by the event data management application). This information will be packaged together and stored on a central server with a digital signature.

When the vehicle is judged a similar process is undertaken with an additional image of the vehicle and VIN. This along with the results of the judging and the judges' signatures will be stored together with a new digital signature. Finally, a final review of the judging results is a final sign-off which is digitally signed.

A final digital signature of the three previous signatures will establish a comparison point similar to hash for downloaded files. If the hash of the downloaded file doesn't match the published hash, it is assumed the file is incomplete, corrupt or tampered with.

If any piece of the record is modified, the digital signatures must be recreated or the records will reflect that the data has been tampered with. If something had to be modified after the fact, the original record, description of the modification and user signature would become the basis for the new digital signature. This process ensures that the data entered into the system during judging remains intact and unchanged.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks has been described with respect to FIGS. 6-9, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

What is claimed is:

1. A method for creating a secure item record from an event, comprising:
receiving, by a network device, event registration information including an event location;
receiving, by the network device, item information of an item to be evaluated at the event;
assigning, by the network device, an enrollment code for the item;
providing, by the network device and to an event participant, the enrollment code;
receiving, by the network device, an item registration record, for the item, with a first digital signature;
receiving, by the network device, an item judging record, for the item, with a second digital signature;
receiving, by the network device, an item judging validation, for the item, with a third digital signature;
generating, by the network device, a hash value from the first, second, and third digital signatures; and
storing, in a memory and as a single record, the item registration record, the item judging record, the item judging validation, and the hash value.

2. The method of claim 1, wherein the item registration record includes:
an enrollment code associating the item with the event, and
one or more of:
a description of the item,
a photograph of the item,
a serial number of the item, and
a photograph of the serial number.

3. The method of claim 1, wherein the item registration record further includes:
location information of the item associated with the time of registration.

4. The method of claim 1, wherein the item judging record includes:
judge information to identify a judge,
item information to identify the item,
the judge's scores, and
one or more of:
another item photograph, or
another VIN photograph.

5. The method of claim 1, wherein the item judging validation includes:
validation information to identify a final reviewer, and
an approval indication of the final reviewer.

6. The method of claim 1, wherein the item registration record, the item judging record, and the item judging validation are received from one or more user device executing an event data management application.

7. The method of claim 1, further comprising:
receiving an authorized modification to the single record, a description of the modification, and digital signature of a user that authorized the modification; and
generating a new hash value for the modified single record based on the modification, the description of the modification and the digital signature of the user that authorized the modification.

8. A method for registering an item at an event, comprising:
scanning, at an event and by a user device, an enrollment code previously obtained from a network device;
associating with the enrollment code, by the user device, an item description and one or more of an item photograph, an item serial number, or a serial number photograph from the item;
obtaining location information of the user device approximate to the time and vicinity of the scanning the enrollment code;
combining, by the user device and in an item registration record, the enrollment code, the location information, the item description, and the one or more of the item photograph, the item serial number, or the serial number photograph;
generating, by the user device, a first digital signature for the item registration record; and
sending to a network device, by the user device, the item registration record with the first digital signature.

9. The method of claim 8, wherein the enrolment code includes a bar code, and wherein the scanning includes capturing an image of the bar code via the user device.

10. The method of claim 8, wherein associating with the enrollment code, the item description, and the one or more of the item photograph, the item serial number, or the serial number photograph from the item includes:
prompting a user, via a user interface of an event data management application, to input information after the scanning the enrollment code.

11. The method of claim 8, wherein generating the first digital signature for the item registration record comprises:
providing an originating key set that is valid only for the duration of the event.

12. The method of claim 8, further comprising:
receiving item information of the item to be evaluated at the event;
assigning an enrollment code for the item; and
providing, to the user device, the enrollment code.

13. The method of claim 8, further comprising:
presenting, by another user device, a judges user interface to receive user input from a judge;
receiving, by the other user device, user input via the judges user interface,
generating, by the user device, a judging record based on the user input.

14. The method of claim 13, wherein the judging record includes:
judge information to identify a judge,
item information to identify the item,
a judging evaluation of the item, and
one or more of:
another item photograph, or
another VIN photograph.

15. A user device, comprising:
a network interface to communicate with one or more remote systems;
a display;
a camera to capture a reality image;
a memory to store instructions; and
a processor configured to execute instructions in the memory to:
scan, using the camera, an enrollment code previously obtained from a network device;
associate with the enrollment code one or more of an item description, an item photograph, an item serial number, and a serial number photograph from the item;
identify a location of the user device proximate to the time and vicinity of the scanning the enrollment code;
combine, in an item registration record, the enrollment code, the location information, and the one or more of the item description, the item photograph, the item serial number, and the serial number photograph;
generate, a digital signature for the item registration record; and
send to a network device the item registration record with the first digital signature.

16. The device of claim 15, wherein the processor is further configured to:
present, to a user, a judges user interface to receive user input from a judge,
receive user input via the judges user interface,
generate a judging record based on the user input, and
send to the network device the judging record with a second digital signature.

17. The device of claim 16, wherein the judging record includes:
judge information to identify a judge,
item information to identify the item,
a judging evaluation of the item, and
one or more of:
another item photograph, or
another VIN photograph.

18. The device of claim 18, wherein the processor is further configured to:
present, to a user, a validation user interface to receive validation input of the judging evaluation,
receive validation input via the validation user interface,
generate a validation record based on the user input, and
send to the network device the validation record with a third digital signature.

19. The device of claim 15, wherein, when associating with the enrollment code, the item description, and the one or more of the item photograph, the item serial number, or the serial number photograph from the item, the processor is further configured to:
prompt a user to input information after the enrollment code is scanned.

20. The device of claim 15, wherein, when generating the first digital signature for the item registration record, the processor is further configured to:
provide an originating key set that is valid only for the duration of the event.
